(19) United States
(12) Patent Application Publication
(10) Pub. No.: US 2003/0041215 A1
(43) Pub. Date: Feb. 27, 2003

(54) Method and apparatus for the utilization of distributed caches

(76) Inventors: Robert T. George, Austin, TX (US); Dennis M. Bell, Gig Harbor, WA (US); Kenneth C. Creta, Gig Harbor, WA (US)

Correspondence Address: KENYON & KENYON (SAN JOSE), 333 WEST SAN CARLOS ST., SUITE 600, SAN JOSE, CA, 95110, US

(21) Appl. No.: 09/940,324

(22) Filed: Aug. 27, 2001

(51) Int. Cl. G06F 12/00

(52) U.S. Cl. 711/141

(57) ABSTRACT

A system and method utilizing distributed caches. More particularly, the present invention pertains to a scalable method of improving the bandwidth and latency performance of caches through the implementation of distributed caches. Distributed caches remove the detrimental architectural and implementation impacts of single monolithic cache systems.

### BACKGROUND OF THE INVENTION

The present invention pertains to a method and apparatus for utilizing distributed caches (e.g., in Very Large-Scale Integration (VLSI) devices). More particularly, the present invention pertains to a scalable method of improving the bandwidth and latency performance of caches through the implementation of distributed caches.

As is known in the art, the system cache in a computer system serves to enhance the system performance of modem computers. For example, a cache can maintain data between a processor and relatively slower system memory by holding recently accessed memory locations in case they are needed again. The presence of cache allows the processor to continuously perform operations utilizing the data in the faster-accessing cache.

Architecturally, system cache is designed as a “monolithic” unit. In order to give a processor core simultaneous read and write access from multiple pipelines, multiple ports can be added to the monolithic cache device. However, there are several detrimental architectural and implementation impacts of using a monolithic cache device with several ports (for example, in a two-port monolithic cache). Current solutions for the two-port monolithic cache device would include multiplexing the servicing of requests from both ports, or providing two sets of address, command, and data ports. The former approach, multiplexing, limits cache performance since the cache resources must be shared amongst the multiple ports. Servicing requests from two ports would halve the effective transaction bandwidth and double the worst-case transaction service latency. The latter approach, providing a separate read/write port for each client device, has the inherent problem of being non-scalable. Adding additional sets of ports as needed, for example, to service five sets of read and write ports, would require five read ports as well as five write ports. On a monolithic cache device, a five-port cache would increase the die size dramatically and become impractical to implement. Furthermore, in order to provide the effective bandwidth of a single port cache device, the new cache would need to support a bandwidth fives times the original cache device. Current monolithic cache devices are not optimized for multiple ports and not the most efficient implementation available.

As is known in the art, multiple cache systems have been utilized in multi-processor computer system designs. A coherency protocol is implemented to ensure that each processor retrieves only the most up-to-date version of data from the cache. In other words, cache coherency is the synchronization of data in a plurality of caches such that reading a memory location via any cache will return the most recent data written to that location via any other cache. MESI (Modified-Exclusive-Shared-Invalid) coherency protocol data can be added to cached data in order to arbitrate and synchronize multiple copies of the same data within various caches. As such, processors are commonly referred to as “cacheable” devices.

However, input/output components (I/O components), such as those coupled to a Peripheral Component Interconnect bus (PCI specification, version 2.1), are generally non-cacheable devices. That is, they typically do not implement the same cache coherency protocol that is used by the processors. Typically, I/O components retrieve data from memory, or a cacheable device, via a Direct Memory Access (DMA) operation. An I/O device may be provided as a connection point between various I/O bridge components, to which I/O components are attached, and ultimately, to the processor.

An input/output (I/O) device may also be utilized as a caching I/O device. That is, the I/O device includes a single, monolithic caching resource for data. Therefore, because an I/O device is typically coupled to several client ports, a monolithic I/O cache device will suffer the same detrimental architectural and performance impacts as previously discussed. Current I/O cache device designs are not efficient implementations for high performance systems.

In view of the above, there is a need for a method and apparatus for utilizing distributed caches in VLSI devices.

### BRIEF DESCRIPTION OF THE DRAWINGS

FIG. 1 is a block diagram of a portion of a processor cache system employing an embodiment of the present invention.

FIG. 2 is a block diagram showing input/output cache device employing an embodiment of embodiment of the present invention.

FIG. 3 is a flow diagram showing an inbound coherent read transaction employing an embodiment of the present invention.

FIG. 4 is a flow diagram showing an inbound coherent write transaction employing an embodiment of the present invention.

### DETAILED DESCRIPTION OF THE DRAWINGS

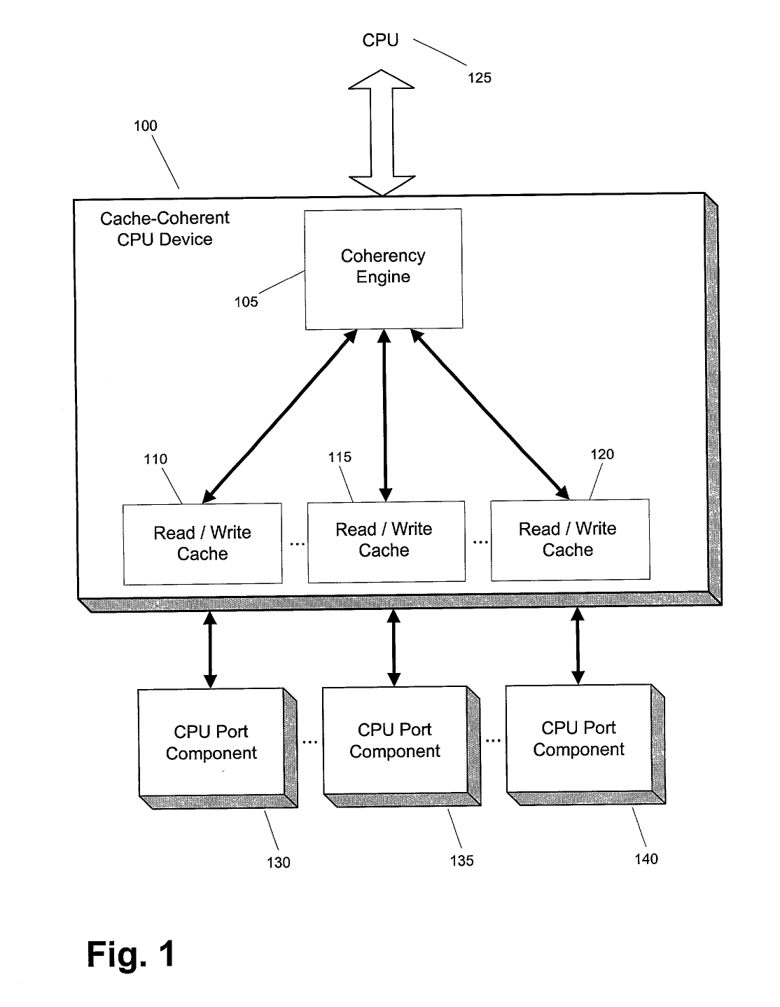

Referring to FIG. 1, a block diagram of a processor cache system employing an embodiment of the present invention is shown. In this embodiment, CPU 125 is a processor that requests data from cache-coherent CPU device 100. The cache-coherent CPU device 100 implements coherency by arbitrating and synchronizing the data within the distributed caches 110, 115, and 120. CPU port components 130, 135 and 140 may include, for example, system RAM. However, any suitable component for the CPU ports may be utilized as port components 130, 135 and 140. In this example, cache-coherent CPU device 100 is part of a chipset that provides a PCI bus to interface with I/O components (described below) and interfaces with system memory and the CPU.

The cache-coherent CPU device 100 includes a coherency engine 105 and one or more read and write caches 110, 115 and 120. In this embodiment of the cache-coherent CPU device 100, coherency engine 105 contains a directory, indexing all the data within distributed caches 110, 115 and 120. The coherency engine 105 may utilize, for example, the Modified-Exclusive-Shared-Invalid (MESI) coherency protocol, labeling the data with line state MESI tags: ‘M’-state (Modified), ‘E’-state (Exclusive), ‘S’-state (Shared), or ‘I’-state (Invalid). Each new request from the cache of any of the CPU component ports 130, 135 or 140 is checked against the directory of coherency engine 105. If the request does not interfere with any data found within any of the other caches, the transaction is processed. Utilizing the MESI tags enables coherency engine 105 to quickly arbitrate between caches reading from and writing to the same data, meanwhile, keeping all data synchronized and tracked between all caches.

Rather than employing a single monolithic cache, cache-coherent CPU device 100 physically partitions the caching resources into smaller, more implementable portions. Caches 110, 115 and 120 are distributed across all ports on the device, such that each cache is associated with a port component. According to an embodiment of the present invention, cache 110 is physically located on the device nearby port component 130 being serviced. Similarly, cache 115 is located proximately to port component 135 and cache 120 is located proximately to port component 140, thereby reducing the latency of transaction data requests. This approach minimizes the latency for “cache hits” and performance is increased. A cache hit is a request to read from memory that may be satisfied from the cache without using main (or another) memory. This arrangement is particularly useful for data that is prefetched by port components 130, 135 and 140.

Furthermore, the distributed cache architecture improves aggregate bandwidth with each port component 130, 135 and 140 capable of utilizing the full transaction bandwidth for each read/write cache 110, 115 and 120. Distributing caches according to this embodiment of the present invention, also provides improvements in scalability design. Using a monolithic cache, an increase in the number of ports would make the CPU device geometrically more complex in design (e.g., a four-port CPU device would be sixteen times more complex using a monolithic cache compared to a one-port CPU device). With this embodiment of the present invention, the addition of another port is easier to design into the CPU device by adding an additional cache for the additional port and the appropriate connections to the coherency engine. Therefore, distributed caches are inherently more scalable.

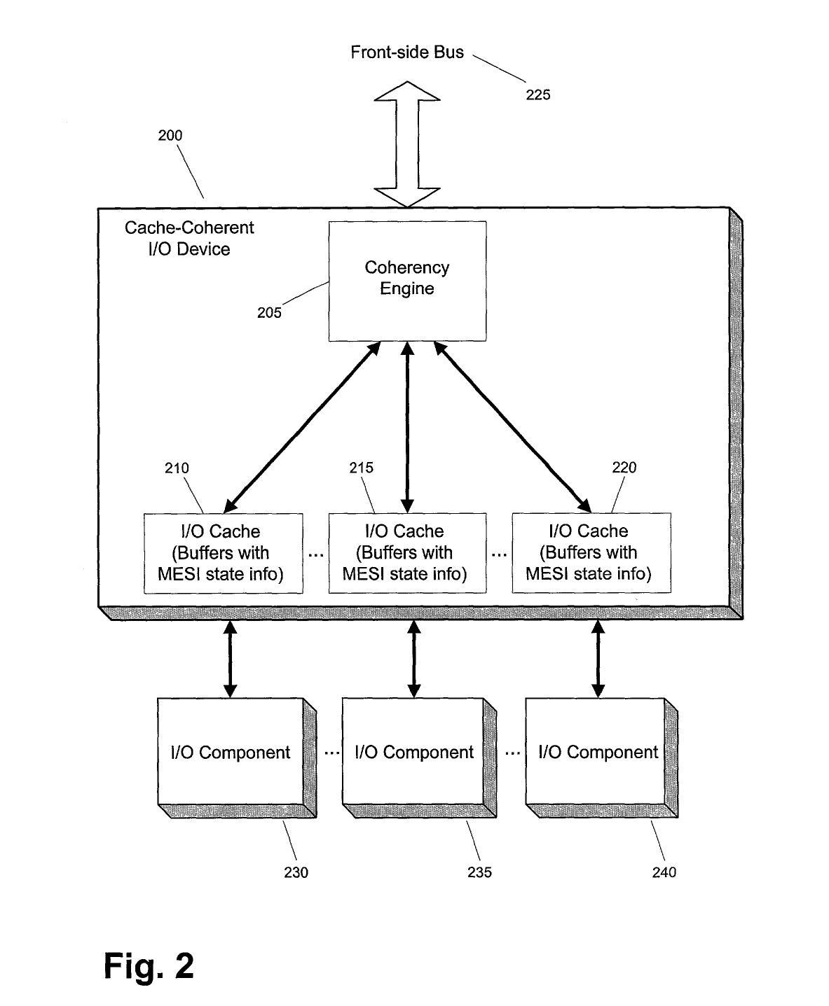

Referring to FIG. 2, a block diagram of an input/output cache device employing an embodiment of the present invention is shown. In this embodiment, cache-coherent I/O device 200 is connected to a coherent host, here, a front-side bus 225. The cache-coherent I/O device 200 implements coherency by arbitrating and synchronizing the data within the distributed caches 210, 215 and 220. A further implementation to improve current systems involves the leveraging of existing transaction buffers to form caches 210, 215 and 220. Buffers are typically present in the internal protocol engines used for external systems and I/O interfaces. These buffers are used to segment and reassemble external transaction requests into sizes that are more suitable to the internal protocol logic. By augmenting these pre-existing buffers with coherency logic and a content addressable memory to track and maintain coherency information, the buffers can be effectively used as MESI coherent caches 210, 215, and 220 implemented within a distributed cache system. I/O components 230, 235 and 240 may include, for example, a disk drive. However, any suitable component or device for the I/O ports may be utilized as I/O components 230, 235 and 240.

The cache-coherent I/O device 200 includes a coherency engine 205 and one or more read and write caches 210, 215 and 220. In this embodiment of the cache-coherent I/O device 200, coherency engine 205 includes a directory, indexing all the data within distributed caches 210, 215 and 220. The coherency engine 205 may utilize, for example, the MESI coherency protocol, labeling the data with line state MESI tags: M-state, E-state, S-state, or I-state. Each new request from the cache of any of the I/O components 230, 235 or 240 is checked against the directory of coherency engine 205. If the request does not represent a coherency conflict with any data found within any of the other caches, the transaction is processed. Utilizing the MESI tags enables coherency engine 205 to quickly arbitrate between caches reading from and writing to the same data, meanwhile, keeping all data synchronized and tracked between all caches.

Rather than employing a single monolithic cache, cache-coherent CPU device 200 physically partitions the caching resources into smaller, more implementable portions. Caches 210, 215 and 220 are distributed across all ports on the device, such that each cache is associated with an I/O component. According to an embodiment of the present invention, cache 210 is physically located on the device nearby I/O component 230 being serviced. Similarly, cache 215 is located proximately to I/O component 235 and cache 220 is located proximately to I/O component 240, thereby reducing the latency of transaction data requests. This approach minimizes the latency for “cache hits” and performance is increased. This arrangement is particularly useful for data that is prefetched by I/O components 230, 235 and 240.

Furthermore, the distributed cache architecture improves aggregate bandwidth with each port component 230, 235 and 240 capable of utilizing the full transaction bandwidth for each read/write cache 210, 215 and 220.

Effective transaction bandwidth in I/O devices is improved in at least two ways by utilizing a cache-coherent I/O device 200. Cache-coherent I/O device 200 may aggressively prefetch data. If cache-coherent device 200 speculatively requests ownership of data subsequently requested or modified by the processor system, caches 210, 215 and 220 may be “snooped” (i.e. monitored) by the processor, which, in turn, will return the data with the correct coherency state preserved. As a result, cache-coherent device 200 can selectively purge contended coherent data, rather than deleting all prefetched data in a non-coherent system where data is modified in one of the prefetch buffers. Therefore, the cache hit rate is increased, thereby increasing performance.

Cache-coherent I/O device 200 also enables pipelining coherent ownership requests for a series of inbound write transactions destined for coherent memory. This is possible because cache-coherent I/O device 200 provides an internal cache which is maintained coherent with respect to system memory. The write transactions can be issued without blocking the ownership requests as they return. Existing I/O devices must block each inbound write transaction, waiting for the system memory controller to complete the transaction before subsequent write transactions may be issued. Pipelining I/O writes significantly improves the aggregate bandwidth of inbound write transactions to coherent memory space.

As seen from the above, the distributed caches serve to enhance overall cache system performance. The distributed caches system enhances the architecture and implementation of a cache system with multiple ports. Specifically within I/O cache systems, distributed caches conserve the internal buffer resources in I/O devices, thereby improving device size, while improving the latency and bandwidth of I/O devices to memory.

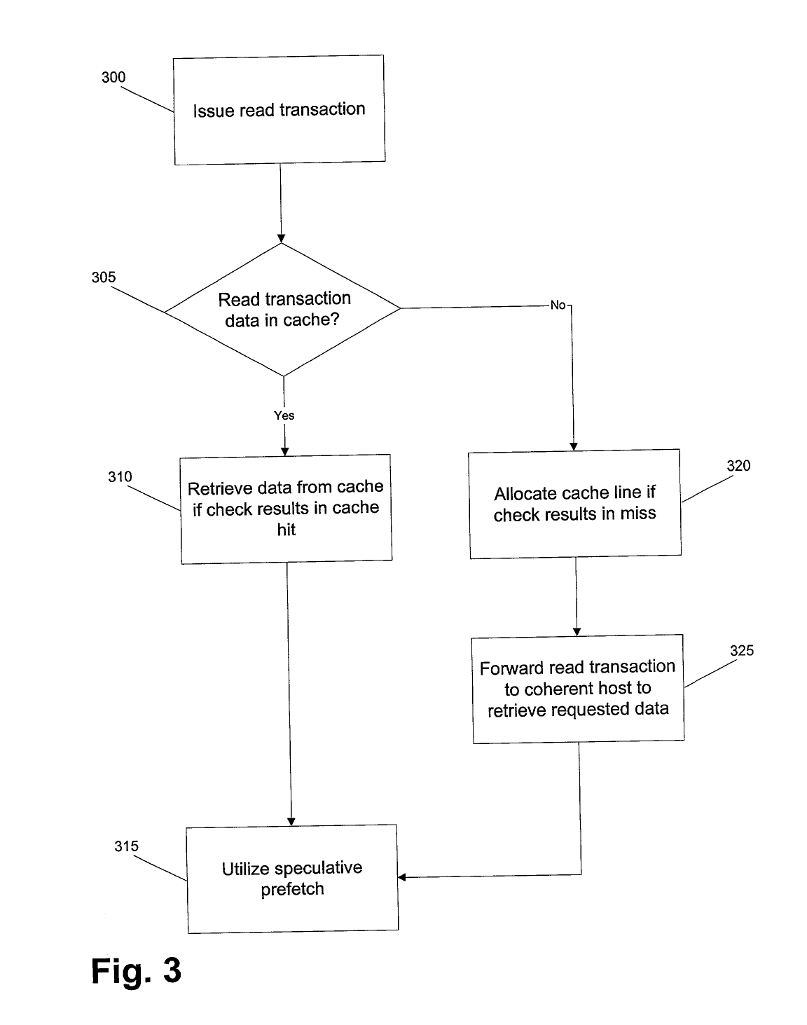

Referring to FIG. 3, a flow diagram of an inbound coherent read transaction employing an embodiment of the present invention is shown. An inbound coherent read transaction originates from port component 130, 135 or 140 (or similarly from I/O component 230, 235 or 240). Accordingly, in block 300, a read transaction is issued. Control is passed to decision block 305, where the address for the read transaction is checked within the distributed caches 110, 115 or 120 (or similarly from caches 210, 215 or 220). If the check results in a cache hit, then the data is retrieved from the cache in block 310. Control then passes to block 315 where speculatively prefetched data in the cache can be utilized to increase the effective read bandwidth and reduce the read transaction latency. If the read transaction data is not found in cache in decision block 305, resulting in a miss, a cache line is allocated for the read transaction request. Control then passes to block 325 where the read transaction is forwarded to the coherent host to retrieve the requested data. In requesting this data, the speculative prefetch mechanism in block 315 can be utilized to increase the cache hit rate by speculatively reading one or more cache lines ahead of the current read request and by maintaining the speculatively read data coherent in the distributed cache.

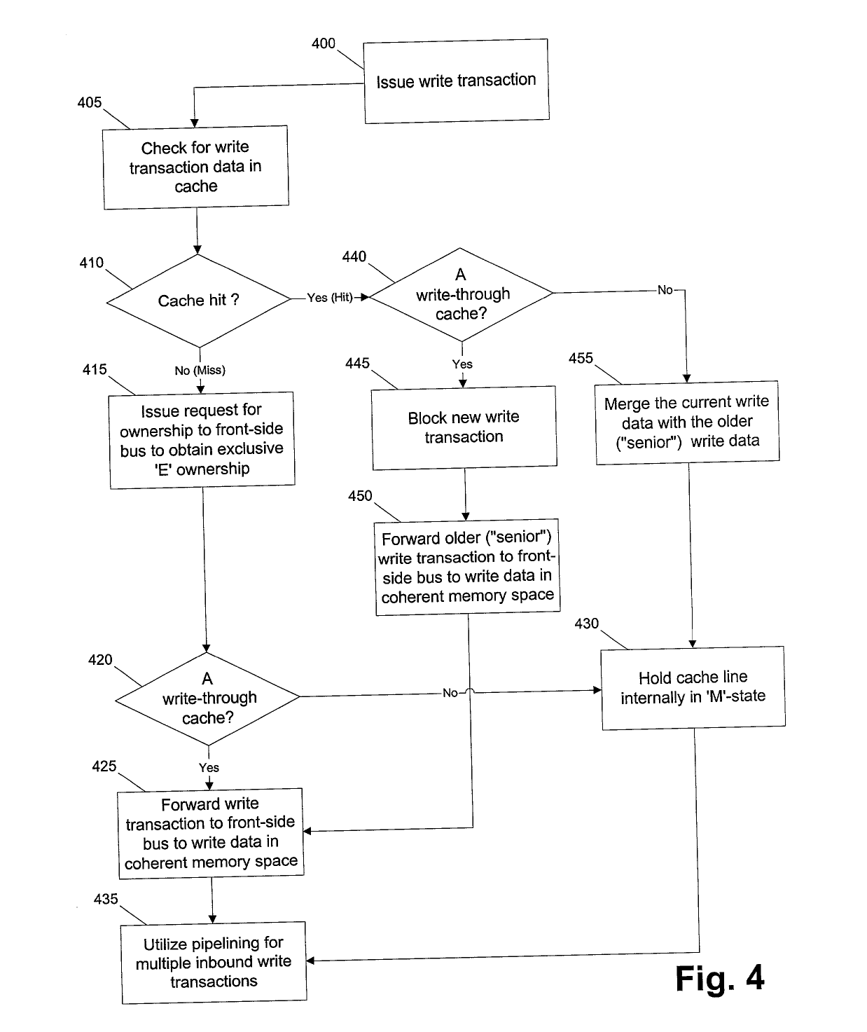

Referring to FIG. 4, a flow diagram of one or more inbound coherent write transactions employing an embodiment of the present invention is shown. An inbound coherent write transaction originates from port component 130, 135 or 140 (or similarly from I/O component 230, 235 or 240). Accordingly, in block 400, a write transaction is issued. Control is passed to block 405, where the address for the write transaction is checked within the distributed caches 110, 115 or 120 (or similarly from caches 210, 215 or 220).

In decision block 410, a determination is made whether the check results in a “cache hit” or “cache miss.” If the cache-coherent device does not have exclusive ‘E’ or modified ‘M’ ownership of the cache line, the check results in a cache miss. Control then passes to block 415, where the cache directory of the coherency engine will forward a “request for ownership” to an external coherency device (e.g. memory) requesting exclusive ‘E’ ownership of the target cache line. When exclusive ownership is granted to the cache-coherent device, the cache directory marks the line as ‘M’. At this point, in decision block 420, the cache directory may either forward the write transaction data to the front-side bus to write data in coherent memory space in block 425, or maintain the data locally in the distributed caches in modified ‘M’-state in block 430. If the cache directory always forwards the write data to the front-side bus upon receiving exclusive ‘E’ ownership of the line, then the cache-coherent device operates as a “write-through” cache, in block 425. If the cache directory maintains the data locally in the distributed caches in modified ‘M’-state, then the cache-coherent device operates as a “write-back” cache, in block 430. In each instance, either forwarding the write transaction data to the front-side bus to write data in coherent memory space in block 425, or maintaining the data locally in the distributed caches in modified ‘M’-state in block 430, control then passes to block 435, where the pipelining capability within distributed caches is utilized.

In block 435, the pipelining capability of global system coherency can be utilized to streamline a series of inbound write transactions, thereby improving the aggregate bandwidth of inbound writes to memory. Since global system coherency will be maintained if the write transaction data is promoted to modified ‘M’-state in the same order it was received from port component 130, 135 or 140 (or similarly from I/O component 230, 235 or 240), the processing of a stream of multiple write requests may be pipelined. In this mode, the cache directory will forward a request for ownership to an external coherency device requesting exclusive ‘E’ ownership of the target cache line as each write request is received from port component 130, 135 or 140 (or similarly from I/O component 230, 235 or 240). When exclusive ownership is granted to the cache-coherent device, the cache directory marks the line as modified ‘M’ as soon as all the preceding writes have also been marked as modified ‘M’. As a result, a series of inbound writes from port component 130, 135 or 140 (or similarly from I/O component 230, 235 or 240) will result in a corresponding series of ownership requests, with the stream of writes being promoted to modified ‘M’-state in the proper order for global system coherency.

If a determination is made that the check results in a “cache hit” in decision block 410, control then passes to decision block 440. If the cache-coherent device already has exclusive ‘E’ or modified ‘M’ ownership of the cache line in one of the other distributed caches, the check results in a cache hit. At this point, in decision block 440, the cache directory will manage the coherency conflict either as a write-through cache, passing control to block 445, or, as a write-back cache, passing control to block 455. If the cache directory always blocks the new write transaction until the senior write data can be forwarded to the front-side bus upon receiving a subsequent write to the same line, then the cache-coherent device operates as a write-through cache. If the cache directory always merges the data from both writes locally in the distributed caches in modified ‘M’-state, then the cache-coherent device operates as a write-back cache. As a write-through cache in block 445, the new write transaction is blocked until the older (“senior”) write transaction data can be forwarded to the front-side bus to write data in coherent memory space in block 450. After the senior write transactions have been forwarded, other write transactions can then be forwarded to the front-side bus to write data in coherent memory space in block 425. Control then passes to block 435, where the pipelining capability of distributed caches is utilized. As a write-back cache in block 455, the data from both writes is merged locally in the distributed caches in modified ‘M’-state, and held internally in modified ‘M’-state in block 430. Again, control passes to block 435, where multiple inbound write transactions may be pipelined, as described above.

Although a single embodiment is specifically illustrated and described herein, it will be appreciated that modifications and variations of the present invention are covered by the above teachings and within the purview of the appended claims without departing from the spirit and intended scope of the invention.

What is claimed is:

1. A cache-coherent device comprising:
a plurality of client ports, each to be coupled to one of a plurality of port components;
a plurality of sub-unit caches, each coupled to one of said plurality of client ports and assigned to one of said plurality of port components; and
a coherency engine coupled to said plurality of sub-unit caches.

2. The device of claim 1 wherein said plurality of port components include processor port components.

3. The device of claim 1 wherein said plurality of port components include input/output components.

4. The device of claim 3 wherein said plurality of sub-unit caches include transaction buffers using a coherency logic protocol.

5. The device of claim 4 wherein said coherency logic protocol includes a Modified-Exclusive-Shared-Invalid (MESI) cache coherency protocol.

6. A processing system comprising:
a processor;
a plurality of port components; and
a cache-coherent device coupled to said processor and including a plurality of client ports, each coupled to one of said plurality of port components, said cache-coherent device further including a plurality of caches, each coupled to one of said plurality of client ports and assigned to one of said plurality of port components, and a coherency engine coupled to said plurality of caches.

7. The processing system of claim 6 wherein said plurality of port components include processor port components.

8. The processing system of claim 6 wherein said plurality of port components include input/output components.

9. In a cache-coherent device including a coherency engine and a plurality of client ports, a method for processing a transaction, comprising:
receiving a transaction request at one of said plurality of client ports, said transaction request includes an address; and
determining whether said address is present in one of a plurality of sub-unit caches, each of said sub-unit caches assigned to said of a plurality of client ports.

10. The method of claim 9 wherein said transaction request is a read transaction request.

11. The method of claim 10 further comprising:
transmitting data for said read transaction request from said one of said plurality of sub-unit caches to one of said plurality of client ports.

12. The method of claim 11 further comprising:
prefetching one or more cache lines ahead of said read transaction request; and
updating the coherency state information in said plurality of sub-unit caches.

13. The method of claim 12 wherein the coherency state information includes a Modified-Exclusive-Shared-Invalid (MESI) cache coherency protocol.

14. The method of claim 9 wherein said transaction request is a write transaction request.

15. The method of claim 14 further comprising:
modifying coherency state information for a cache line in said one of said plurality of sub-unit caches;
updating coherency state information in others of said plurality of sub-unit caches by said coherency engine; and
transmitting data for said write transaction request from said one of said plurality of sub-unit caches to memory.

16. The method of claim 15 further comprising:
modifying coherency state information of said write transaction request in the order received; and
pipelining multiple write requests.

17. The method of claim 16 wherein the coherency state information includes a Modified-Exclusive-Shared-Invalid (MESI) cache coherency protocol.
